(19) United States
(12) Patent Application Publication
(10) Pub. No.: US 2014/0018972 A1
(43) Pub. Date: Jan. 16, 2014

(54) ENCLOSURE TEMPERATURE SCRIPT INTERPRETER

(71) Applicants: Michael G. MYRAH, Cypress, TX (US); Balaji NATRAJAN, Spring, TX (US); Martin R. ROGOFF, Houston, TX (US)

(72) Inventors: Michael G. MYRAH, Cypress, TX (US); Balaji NATRAJAN, Spring, TX (US); Martin R. ROGOFF, Houston, TX (US)

(21) Appl. No.: 13/545,038

(22) Filed: Jul. 10, 2012

(51) Int. Cl. G05D 23/00

(52) U.S. Cl. 700/300

(57) ABSTRACT

In an enclosure to house computing components, the enclosure includes a temperature control processor, and temperature control script interpreter logic. The temperature control script interpreter logic causes the processor to maintain the interior temperature of the enclosure in accordance with the temperature control script.

### BACKGROUND

An enclosure for housing computer system or other electronic components, such as secondary storage devices, server modules, etc., may include a temperature control system to manage the temperature of the enclosure interior. Manufacturers of the computer system components housed in the enclosure specify the temperature ranges at which the components are operable. Because operation of the components at temperatures beyond those specified by the manufacturers may detrimentally affect component life, the temperature control system may be designed to maintain the housed components within the operational temperature ranges specified by the component's manufacturers.

### BRIEF DESCRIPTION OF THE DRAWINGS

For a detailed description of various illustrative examples, reference will now be made to the accompanying drawings in which:

FIGS. 1 and 2 show block diagrams for enclosures including a temperature control script interpreter in accordance with principles disclosed herein;

FIG. 3 shows a block diagram of a computer-readable medium encoded with instructions for a control script interpreter in accordance with principles disclosed herein; and

FIGS. 4 and 5 show flow diagrams for methods for controlling the temperature of an enclosure in accordance with principles disclosed herein.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect, direct, optical or wireless connection. Thus, if a first device couples to a second device, that connection may be through a direct connection, through an indirect connection via other devices and connection. The recitation “based on” is intended to mean “based at least in part on.” Therefore, if X is based on Y, X may be based on Y and any number of other factors. An “enclosure” is a housing for computer or other electronic components that provides thermal management for the components.

### DETAILED DESCRIPTION

The following discussion is directed to various implementations of temperature control for a computing device enclosure. Although one or more of these implementations may be preferred, the implementations disclosed should not be interpreted, or otherwise used, as limiting the scope of the disclosure, including the claims. In addition, one skilled in the art will understand that the following description has broad application, and the discussion of any implementation is illustrative and is not intended to intimate that the scope of the disclosure, including the claims, is limited to that implementation.

A conventional temperature control system included in a computing system enclosure is intended to maintain the interior of the enclosure within a predetermined temperature range. Unfortunately, the temperature range maintained by the temperature control system may be undesirable or unacceptable for use in a given datacenter or application of the enclosure. For example, a datacenter operator may desire that the interior of the enclosure be maintained at a temperature lower than predetermined temperature in an attempt to increase component life, or that the interior of the enclosure be maintained at a temperature higher than the predetermined temperature in an attempt to decrease cooling costs.

The enclosures and temperature control systems disclosed herein allow datacenter operators to specify the temperature control processes performed by the temperature control system after delivery of the enclosure to the datacenter. The enclosure temperature control systems of the present disclosure include a temperature control script interpreter that can execute temperature control scripts created by an end user of an enclosure. The temperature control scripts include statements that are interpretively executed via the temperature control script interpreter to provide the custom enclosure interior temperatures, air flow rate changes, etc. required to meet the specifications of a particular datacenter or application.

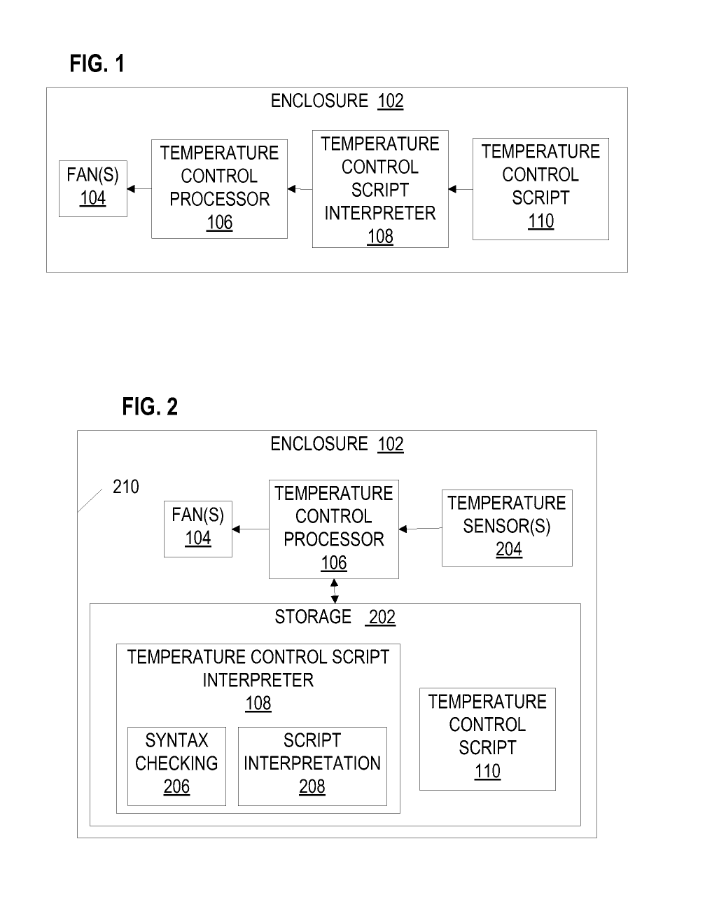

FIGS. 1 and 2 show block diagrams for an enclosure 102 including a temperature control script interpreter 108 in accordance with principles disclosed herein. The enclosure 102 includes an outer casing 210, and may contain various computing components, such as hard drives, server boards, etc. For controlling the temperature of the interior of the enclosure 102, the enclosure 102 includes at least one fan 104, temperature sensors 204, and a temperature control processor 106. The fan(s) 104 move air through the interior of the enclosure 102. The temperature sensor(s) 204 are positioned within the enclosure 102 to measure the temperatures at various locations within the enclosure 102.

The temperature control processor 106 controls the fan(s) 104 to manage the airflow within the enclosure 102. The temperature control processor 106 may be embodied in an enclosure processor that controls various functions associated with the enclosure 102, or may be dedicated to temperature control. The temperature control processor 106 is coupled to the temperature sensor(s) 204 and the fan(s) 104. The processor 106 retrieves temperature measurement values from the temperature sensor(s) 204 and adjusts the rate of air movement within the enclosure 102 by adjusting the speed of the fan(s) 104 based on the temperature measurements.

The temperature control processor 106 may be, for example, a general-purpose microprocessor, digital signal processor, microcontrollers, or other device configured to execute instructions for performing operations disclosed herein. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems.

The storage 202 stores software programming (i.e., processor executable instructions) that the temperature control processor 106 executes to perform the enclosure temperature control functions disclosed herein. The storage 202 is a non-transitory computer-readable storage medium. A computer-readable storage medium may include volatile storage such as random access memory, non-volatile storage (e.g., a hard drive, an optical storage device (e.g., CD or DVD), FLASH storage, read-only-memory), or combinations thereof. Processors execute software instructions. Software instructions alone are incapable of performing a function. Therefore, in the present disclosure, any reference to a function performed by software instructions, or to software instructions performing a function is simply a shorthand means for stating that the function is performed by a processor executing the instructions.

The storage 202 includes a temperature control script interpreter module 108. The temperature control script interpreter 108, when executed by the temperature control processor 106, translates the textual statements of a temperature control script 110 included in the storage 202 into instructions executable by the processor 106, and executes the instructions to manage the internal temperature of the enclosure 102. Inclusion of the temperature control script interpreter 108 in the enclosure 102 allows a datacenter operator or other user of the enclosure 102 to create and implement a temperature control script 110 that includes textual statements defining how the temperature of the interior of the enclosure 102 is to be controlled. For example, the temperature control script 110 may include statements that are interpretively executed to cause the temperature control processor 106 to retrieve temperature measurements from the temperature sensor(s) 204, and adjust the speed of the fan(s) 104 based on the measured temperatures. The temperature control script 110 may also include statements that control the rate of fan speed change, set a temperature warning level, and issue a warning when the interior temperature of the enclosure exceeds the temperature warning level, etc.

The temperature control script interpreter 108 includes syntax checking logic 206 and script interpretation logic 208. The script interpretation logic 208 includes instructions executable by the temperature control processor 106 to translate the textual statements of the temperature control script 110 and execute the instructions generated by the translation. The script interpretation logic 208 may also include instructions that override the statements of the temperature control script 110 if execution of the temperature control script results in inadequate cooling of the enclosure 102. For example, if the temperature of the enclosure 102 exceeds a predefined temperature, then the script interpretation logic 208 may increase the speed of the fan(s) 104 at a higher rate and/or to a higher speed than that specified by the temperature control script 110. In some implementations of the enclosure 102, the script override functionality may be provided via instructions separate from the temperature control script interpreter 108.

The syntax checking logic 206 includes instructions executable by the temperature control processor 106 to parse the statements of the temperature control script 110 and verify that the statements comply with the rules of the temperature control scripting language interpretively executed by the temperature control script interpreter 108. The syntax checking may include generating an error indicator if the temperature control script fails to comply with the rules of the temperature control scripting language. The syntax checking may also include comparing a temperature warning level value defined by the temperature control script 110 to a predetermined maximum temperature warning level value, and generating an error indication if the defined warning temperature exceeds the predefined maximum temperature.

An example of a user created temperature control script 110 that can be interpreted by the temperature control script interpreter 108 to provide custom management of the interior temperature of the enclosure 102 is shown below. The illustrative script provides custom user defined temperature trigger values, fan speed change rates, and temperature warning levels. The temperature control scripting language may provide various built-in functions through which a temperature control script can access temperature control resources of the enclosure 102, such as temperature sensor(s) 204, fan(s) 104, etc. For example, the script below accesses built-in functions temp_sensor_xx( ) getFanRPM( ) setFanRPM( ) temp_backplane_sensor_warning_{—}01( ) minFanRPM( ) and maxFanRPM( )

// Entry point. Periodically executed by the temperature
control processor. User implemented.
function temp_control( )
{
// retrieve temperature measurements

| var temp1 = temp_sensor_01( ); | |
|---|---|
| var temp2 = temp_sensor_02( ); | |
| var temp3 = temp_sensor_03( ); | |
| var temp4 = temp_sensor_04( ); | |
| var temp5 = temp_sensor_05( ); | |
| var temp6 = temp_sensor_06( ); | |
| // compare measurements to temperature limit | |
| if( | temp1 > 46 \|\| |

temp2 > 46 ||
temp3 > 46 ||
temp4 > 46 ||
temp5 > 46 ||
temp6 > 46 )

{

rampUp( ); // increase fan speed

}
else
{

rampDown( ); // decrease fan speed

}
// Also, detect which temps are critical/warning, then

call:

// temp_backplane_sensor_warning_01(true);
// or
// temp_backplane_sensor_warning_01(false);

}
// User defined fan speed decrease
function rampDown( )
{

var fanRPM = getFanRPM( );
if( (fanRPM − 100) > minFanRPM( ) ) {

fanRPM −= 100;

}
else
{

fanRPM = minFanRPM( );

}
setFanRPM( fanRPM );

}
// User defined fan speed increase
function rampUp( )
{

var fanRPM = getFanRPM( );
if( (fanRPM + 100) < maxFanRPM( ) )
{

fanRPM += 100;

}
else
{

fanRPM = maxFanRPM( );

}
setFanRPM( fanRPM );

}

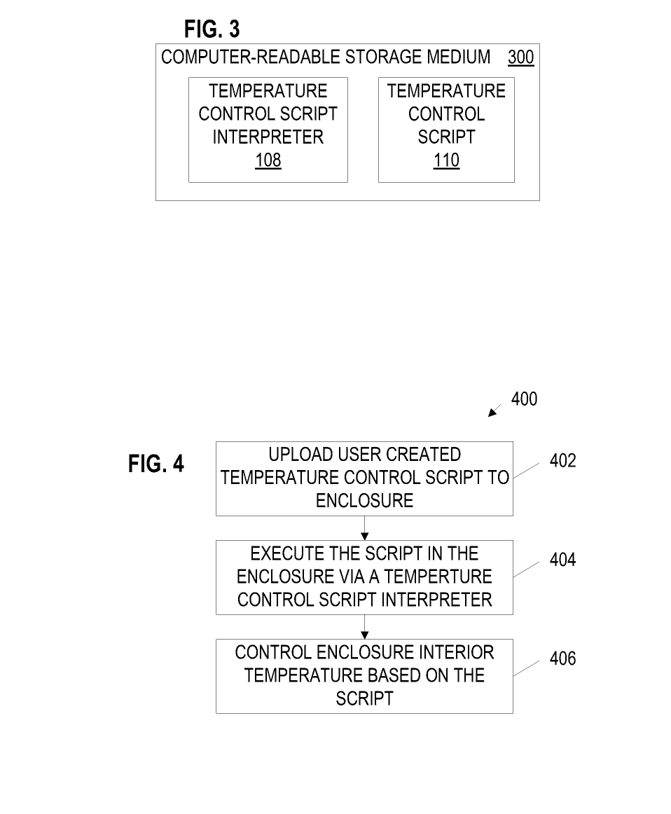

The storage 202 may also contain a default temperature control script or temperature control program that the temperature control processor 106 executes to control the temperature within the enclosure 102 if a user created temperature control script 110 has not been loaded or cannot be interpretively executed, e.g., due to syntax errors. FIG. 3 shows a block diagram of an example of a computer-readable storage medium 300 (magnetic or optical disk, semiconductor memory, etc.) that includes the temperature control script interpreter 108 and a temperature control script 110.

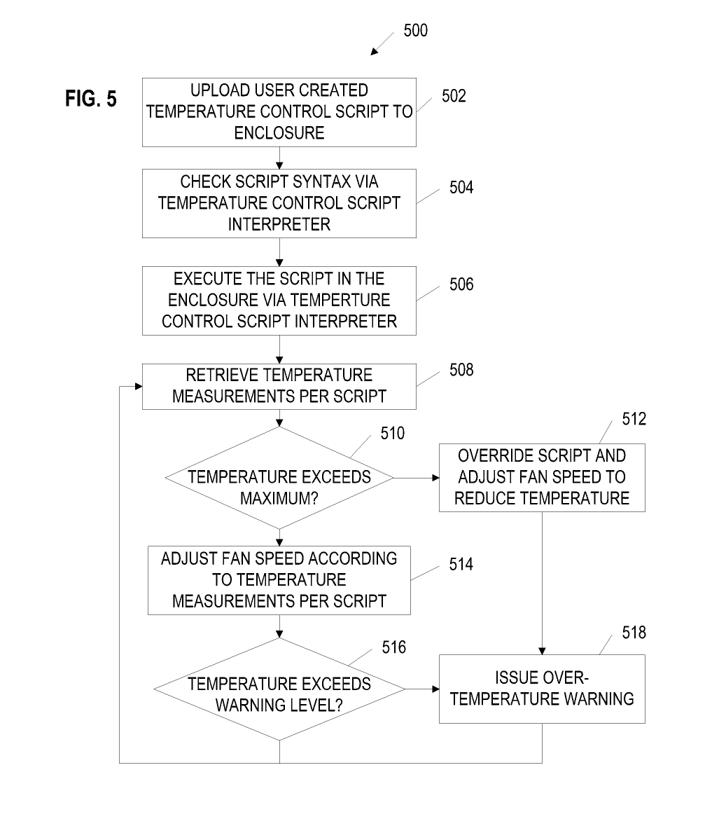

FIG. 4 shows a flow diagram for a method 400 for controlling the interior temperature of an enclosure in accordance with principles disclosed herein. Though depicted sequentially as a matter of convenience, at least some of the actions shown can be performed in a different order and/or performed in parallel. Additionally, some implementations may perform only some of the actions shown. At least some of the operations of the method 400 can be performed by a processor (e.g., temperature control processor 106) executing instructions read from a computer-readable medium (e.g., storage 202).

In block 402, a user of the enclosure 102 creates a custom temperature control script 110 for managing the internal temperature of the enclosure 102 as required in the user's unique location or application. For example, the user may enter statements in the temperature control scripting language using text editor executing on a computer workstation. The temperature control script 110 includes a set of textual statements written in a temperature control scripting language that is interpretively executable by the enclosure 102. The user created temperature control script 110 is uploaded (e.g., transferred, copied, etc.) to the enclosure 102 (via a network, attachment of a memory device, etc.) and stored in the storage 202. In some implementations, the user may enter the temperature control script 110 via a terminal coupled to the enclosure 102.

In block 404, the temperature control processor 106 of the enclosure 102 executes the temperature control script interpreter 108. The temperature control script interpreter 108 includes 1) instructions executable by the temperature control processor 106 to translate textual statements written in the temperature control scripting language to instructions executable by the temperature control processor 106, and 2) instructions to cause the temperature control processor 106 to execute the instructions generated by the translation.

The temperature control processor 106 executes, via the temperature control script interpreter 108, the temperature control script 110 uploaded to the enclosure 102. With execution of the temperature control script 110, the temperature control processor 106 controls the temperature of the interior of the enclosure 102 in accordance with the custom temperature control parameters defined in the temperature control script 110 in block 406.

FIG. 5 shows a flow diagram for a method 500 for controlling the interior temperature of an enclosure in accordance with principles disclosed herein. Though depicted sequentially as a matter of convenience, at least some of the actions shown can be performed in a different order and/or performed in parallel. Additionally, some implementations may perform only some of the actions shown. At least some of the operations of the method 500 can be performed by a processor (e.g., temperature control processor 106) executing instructions read from a computer-readable medium (e.g., storage 202).

In block 502, a user of the enclosure 102 creates a custom temperature control script 110 for managing the internal temperature of the enclosure 102 as required in the user's unique location or application. The temperature control script 110 includes a set of textual statements written in a temperature control scripting language that is interpretively executable by the enclosure 102. The user created temperature control script 110 is uploaded to the enclosure 102 and stored in the storage 202.

In block 504, the temperature control processor 106 of the enclosure 102 executes the temperature control script interpreter 108. The temperature control script interpreter 108 includes instructions executable by the temperature control processor 106 to check the syntax of textual statements written in the temperature control scripting language. If syntax errors are detected, an error indication may be generated, and/or the temperature control script 110 may not be executed. The syntax checking may also include analysis of script statements to ensure that the script 110 operates the enclosure 102 within predetermined limits. For example, if the script 110 defines an excessively high warning temperature value (e.g., 100° Celsius), then the syntax checking may deem the script 110 to be in error.

The temperature control script interpreter 108 also includes instructions executable by the temperature control processor 106 to translate textual statements written in the temperature control scripting language to instructions executable by the temperature control 106, and instructions to cause the temperature control processor 106 to execute the instructions generated by the translation. In block 506, the temperature control processor 106 executes the temperature control script 110 via the temperature control script interpreter 108, thereby implementing the user created temperature control process in the enclosure 102.

In block 508, responsive to execution of the temperature control script 110, the temperature control processor 106 retrieves temperature measurement values from temperature sensors 204 disposed in the enclosure 102. The temperature control processor 106 compares the temperature measurements to a predetermined maximum temperature value in block 508. The predetermined maximum temperature value may not be changeable via the temperature control script 110.

If the measured temperature values exceed the predetermined maximum temperature value, then the temperature control processor 106 overrides the custom temperature control process defined in the temperature control script 110, and adjusts the speed of the fan(s) 104 to reduce the internal temperature of the enclosure 102 in block 512. The temperature control processor 106 may issue an over temperature warning in block 518.

If the measured temperature values do not exceed the predetermined maximum temperature value, then the temperature control processor 106 adjusts the speed of the fan(s) 104 based on the temperature measurements in accordance with the temperature control script 110 in block 514.

In block 516, responsive to execution of the temperature control script 110, the temperature control processor 106 determines whether the measured temperature values exceed a warning level defined in the temperature control script 110. If the measured temperature values exceed the warning level defined in the temperature control script 110, then the temperature control processor 106 issues an over-temperature warning in block 518.

The above discussion is meant to be illustrative of the principles and various implementations of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
an enclosure to house computing components, the enclosure comprising:
a fan to move air through the enclosure;
a temperature control processor coupled to the fan; and
temperature control script interpreter logic that causes the temperature control processor to:
translate textual statements of a temperature control script to instructions executable by the temperature control processor; and
execute the instructions to control the fan and maintain interior temperature of the enclosure in accordance the temperature control script.

2. The system of claim 1, wherein the enclosure further comprises a plurality of temperature sensors coupled to the temperature control processor; and the temperature control script comprises a statement that when executed causes the processor to retrieve a temperature measurement from a selected one of the sensors.

3. The system of claim 1, wherein the temperature control script comprises a statement that when executed causes the temperature control processor to adjust speed of the fan based on a value of temperature measured within the enclosure.

4. The system of claim 3, wherein the temperature control script causes the temperature control processor to increase fan speed based on the value of temperature exceeding a temperature specified in the temperature control script, and to reduce fan speed based on the value of temperature not exceeding the temperature specified in the temperature control script.

5. The system of claim 1, wherein the temperature control processor is to override the temperature control script based on execution of the temperature control script causing the interior temperature of the enclosure to exceed a predetermined maximum temperature.

6. The system of claim 1, wherein the temperature control script comprises a temperature warning level value that cause the temperature control processor to issue a temperature warning based on the interior temperature of the enclosure exceeding the temperature warning level value, and wherein the temperature control script interpreter logic causes the processor to deem the temperature control script to be in error based on the temperature warning level value exceeding a predetermined maximum temperature warning level value.

7. The system of claim 1, wherein the temperature control script is user generated, the processor is to upload text of the temperature control script to the enclosure, and the temperature control script interpreter logic causes the processor to check syntax of the text of the temperature control script prior to execution of the temperature control script.

8. A method, comprising:
uploading a user created temperature control script to a computing component enclosure;
executing interpretively, by a processor executing a temperature control script interpreter, the temperature control script; and
controlling interior temperature of the enclosure based on executing the temperature control script.

9. The method of claim 8, further comprising:
checking, by the processor executing the temperature control script interpreter, syntax of the temperature control script responsive to the uploading; and
rejecting, based on the checking, a temperature warning level value specified by the script based on the temperature warning level value exceeding a predetermined maximum temperature warning level value.

10. The method of claim 8, wherein the controlling comprises
retrieving a temperature measurement from a temperature sensor based on execution of a statement of the temperature control script; and
adjusting speed of a fan of the enclosure based on a statement of the temperature control script that causes fan speed adjustment based on the temperature measurement.

11. The method of claim 8, further comprising overriding the temperature control script based on the executing of the temperature control script causing the interior temperature of the enclosure to exceed a predetermined maximum temperature.

12. The method of claim 8, further comprising issuing an over-temperature warning based on the executing of the temperature control script and enclosure interior temperature exceeding a temperature control script specified maximum enclosure interior temperature value.

13. A non-transitory computer-readable storage medium encoded with instructions that when executed cause a processor that controls interior temperature of a computing device enclosure to:
execute a temperature control script interpreter;
interpretively execute a temperature control script via the temperature control script interpreter, the temperature control script comprising statements that when interpretively executed cause the processor to:
retrieve a temperature measurement from each of a plurality of temperature sensors of the enclosure; and
adjust the speed of a fan of the enclosure in accordance with the temperature measurements and a temperature limit specified by the temperature control script.

14. The computer-readable medium of claim 13 further comprising instructions that cause the processor to:
upload the temperature control script, wherein the temperature control script is user created;
check, by execution of the temperature control script interpreter, syntax of the temperature control script prior to execution of the temperature control script; and
reject, by execution of the temperature control script interpreter, a temperature warning level value specified by a statement of the script based on the temperature warning level value exceeding a predetermined maximum temperature warning level value.

15. The computer-readable medium of claim 13 further comprising instructions that cause the processor to:
issue an over-temperature warning based on execution of the temperature control script and enclosure interior temperature exceeding a temperature warning level value specified in a statement of the temperature control script; and
override the temperature control script based on execution of the temperature control script causing the interior temperature of the enclosure to exceed a predetermined maximum temperature.
